(19) United States
(12) Patent Application Publication
(10) Pub. No.: US 2017/0040040 A1
(43) Pub. Date: Feb. 9, 2017

(54) VIDEO INFORMATION PROCESSING SYSTEM

(71) Applicant: HITACHI, LTD., Tokyo (JP)

(72) Inventors: Hirokazu IKEDA, Tokyo (JP); Jiabin HUANG, Tampines Grande (SG)

(73) Assignee: HITACHI, LTD., Tokyo (JP)

(21) Appl. No.: 15/102,956

(22) PCT Filed: Nov. 25, 2014
(86) PCT No.: PCT/JP2014/081105

§ 371 Date: Jun. 9, 2016

(30) Foreign Application Priority Data
Jan. 17, 2014 (JP) 2014-006384

(51) Int. Cl. G11B 27/10; G06F 17/30; G06K 9/00; G11B 27/02; G06K 9/62; G11B 27/00

(52) U.S. Cl. CPC G11B 27/102; G06K 9/6215; G11B 27/005; G06K 9/00718; G11B 27/02; G06F 17/3079; G06K 9/00228; G06K 2209/21

(57) ABSTRACT

There is provided a video information processing system comprising: a target recognition module configured to detect, from among the plurality of still images, still images in which a search target is present based on a determination of a similarity degree with registration data of the search target using a first threshold; and a time band determination module configured to determine, in a case where an interval between the still images in which the search target is determined as being present is a second threshold or less, that the search target is also present in a still image between the still images in which the search target is determined as being present. The video information processing system registers a start time and an end time of the continuous still images in which the search target is determined as being present in association with the registration data of the search target.

### INCORPORATE BY REFERENCE

The present application claims priority from Japanese patent application JP 2014-6384 filed on Jan. 17, 2014, the content of which is hereby incorporated by reference into this application.

### BACKGROUND OF THE INVENTION

This invention relates to a video information processing system configured to analyze and quickly search video.

Hitherto, video content that has been broadcast and video footages of such content have been recorded on inexpensive tape devices in an analog format for long term storage (archiving). In order to easily reuse such an archive, archive video is increasingly converted into digital data and stored online or in a similar form. In order to retrieve target video from the archive, electronically adding (indexing) details about the performers and the content as additional information to the video is useful. In particular, an editor of a television program may need to instantly retrieve from the archive a video clip of a time band in which a specific person or object is shown, and hence how the detailed additional information (e.g., what is shown in which time band) is to be assigned is a problem that needs to be solved.

A typical face detection algorithm employs still images (frames). In order to reduce the heavy processing load, the frames (e.g., 30 frames per second (fps)) are thinned in advance, and face detection is performed on the frames obtained as a result of thinning. During face detection, pattern matching is performed with reference data in which a face image and the name (text) of a specific person form a pair, and when a similarity degree is higher than a predetermined threshold, the detected face is determined to be that of the relevant person.

For example, in US 2007/0274596 A1, there is disclosed an image processing apparatus configured to detect scene changes and to divide an entire video into three scenes, namely, scenes 1 to 3. Further, the image processing apparatus is configured to perform face detection on the still images forming the video. A determination regarding whether or not each scene is a face scene in which the face of a person is shown is performed based on pattern recognition using: data obtained by modeling in time series a feature, e.g., a position of a face detected from the still images forming the face scene or an area of the detected face, which is obtained from each of the still images forming the face scene; and information on a position and an area of a portion detected as being a face from the still images forming the scene for which the determination is to be made.

In face detection technology based on frame units, when the threshold is set to a high value, only a few frames having a good accuracy are detected. However, there are drawbacks in that an operation for specifying the surrounding video in which a specific person is shown is necessary, and a likelihood of missed detections increases. In contrast, when the threshold is set to a low value, missed detections are reduced, but on the other hand, the number of falsely detected frames increases, which means that an operation for determining each individual frame needs to be performed. Further, in the technology disclosed in US 2007/0274596 A1, only the timing of a scene change for the entire video is given. The image processing apparatus disclosed in US 2007/0274596 A1 is not capable of handling a case in which, when a plurality of people are shown simultaneously, the start timing and the end timing are different for each person. As a result, there is a need for a technology (video information indexing) configured to appropriately set the threshold for pattern matching, and to individually set the start time and the end time at which a plurality of people (or objects) are shown.

### SUMMARY OF THE INVENTION

The representative one of inventions disclosed in this application is outlined as follows. There is provided a video information processing system for processing a moving image formed of a plurality of still images in times series, comprising: a target recognition module configured to detect, from among the plurality of still images, still images in which a search target is present based on a determination of a similarity degree with registration data of the search target using a first threshold; and a time band determination module configured to determine, in a case where an interval between the still images in which the search target is determined as being present is a second threshold or less, that the search target is also present in a still image between the still images in which the search target is determined as being present. The video information processing system is configured to register a start time and an end time of the continuous still images in which the search target is determined as being present in association with the registration data of the search target.

According to the representative embodiment of this invention, a video clip of a time band in which a specific person or a specific object is shown can be easily retrieved from a large amount of video footage and archives.

### BRIEF DESCRIPTION OF THE DRAWINGS

FIG. 1 is a diagram illustrating a concept of a video information indexing processing.

FIG. 2 is a block diagram illustrating one example of a video information processing system according to an embodiment of this invention.

FIG. 3 is a flowchart of a recognition frame data generation processing.

FIG. 4 is a diagram illustrating one example of a data structure of reference dictionary data.

FIG. 5 is a diagram illustrating one example of a data structure of recognition frame data.

FIG. 6 is a flowchart of a recognition time band data generation processing.

FIG. 7 is a diagram illustrating one example of a data structure of recognition frame data after correction.

FIG. 8 is a diagram illustrating one example of a data structure of recognition time band data.

FIG. 9 is a flowchart of a recognition time band data correction processing.

FIG. 10 is a flowchart of a video information indexing processing according to a second embodiment of this invention.

FIG. 11 is a flowchart of a recognition frame data generation processing according to a second embodiment of this invention.

FIG. 12 is a diagram illustrating one example of a data structure of recognition frame data according to a second embodiment of this invention.

FIG. 13 is a diagram illustrating a screen output example of a number of target person together recognition time bands according to a second embodiment of this invention.

FIG. 14 is a diagram illustrating a screen output example of a video information search result.

FIG. 15 is a diagram illustrating a screen output example for playing back video clip.

### DETAILED DESCRIPTION OF THE PREFERRED EMBODIMENTS

### First Embodiment

Embodiments of this invention are now described below. In the following description, the term “program” may sometimes be used as the subject of a sentence describing processing. However, in such a case, predetermined processing is performed by a processor (e.g., central processing unit (CPU)) included in a controller executing the program while appropriately using storage resources (e.g., memory) and/or a communication interface device (e.g., communication port). Therefore, the sentence subject of such processing may be considered as being the processor. Further, processing described using a sentence in which a “module” or a program is the subject may be considered as being processing executed by a processor or a management system including the processor (e.g., a management computer (e.g., server)). In addition, the controller may be a processor per se, or may include a hardware circuit configured to perform a part or all of the processing performed by the controller. Programs may be installed in each controller from a program source. The program source may be, for example, a program delivery server or a storage medium.

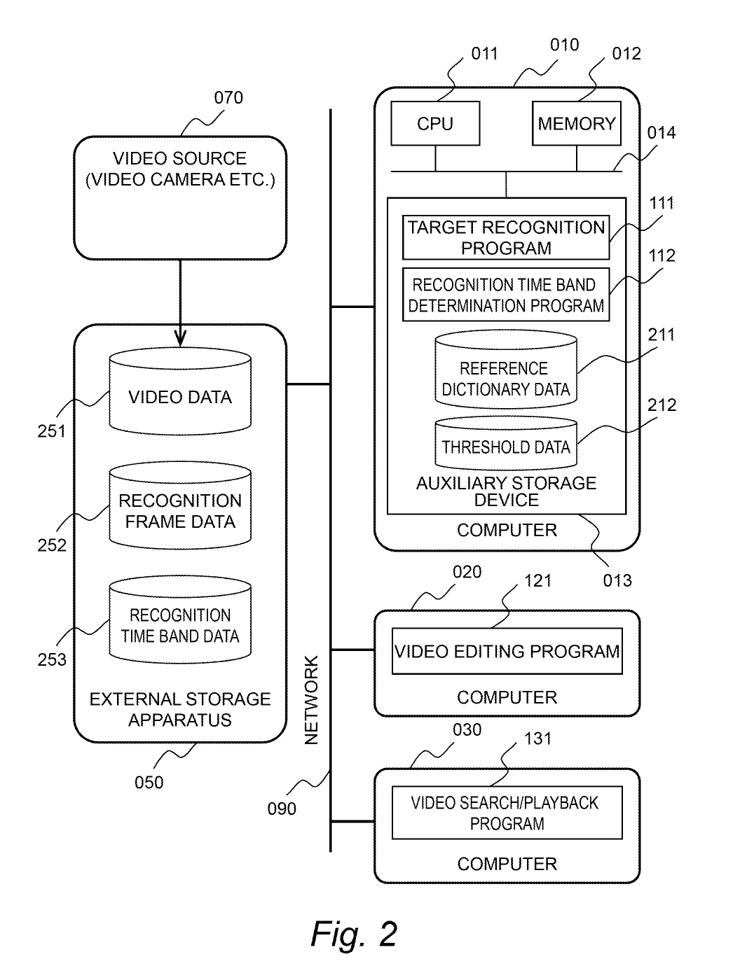

In FIG. 2, one example of a video information processing system according to this embodiment is illustrated. The video information processing system includes an external storage apparatus 050 configured to store video data 251, and computers 010, 020, and 030. The number of computers does not need to be three, as long as the functions described later can be performed. The external storage apparatus 050 may be a high-performance and high-reliability storage system, a direct-attached storage (DAS) apparatus without redundancy, or an apparatus configured to store all data in an auxiliary storage device 013 in the computer 010.

The external storage apparatus 050 and the computers 010, 020, and 030 are coupled to each other via a network 090. In general, a local area network (LAN) connection by an Internet Protocol (IP) router is used, but a wide-area distributed network via a wide-area network (WAN) may also be used, such as when performing remote operation. In a case where rapid input/output (I/O) is required, such as for an editing operation or video distribution, the external storage apparatus 050 may be configured to use a storage area network (SAN) connection by a fibre channel (FC) router on the backend side. A video editing program 121 and a video search/playback program 131 may be entirely executed on the computers 020 and 030, respectively, or may each be operated by a thin client such as a laptop computer, a tablet terminal, or a smartphone.

The video data 251 is usually formed of a large number of video files, such as video footage shot by a video camera and the like, or archive data of a television program broadcast in the past. However, those video files may also be some other type of video data. The video data 251 is presumed to have been converted into a processable format (Moving Picture Experts Group (MPEG) 2 etc.) by recognition means (target recognition program 111 etc.). The video data 251 input from a video source 070 is processed by the target recognition program 111, which is described later, to recognize a target person or a target object based on frame units, resulting in addition of recognition frame data 252. Further, recognition time band data 253 obtained by collecting recognition data (recognition frame data 252) in frame units for each time band by a recognition time band determination program 112, which is described later, is also added.

The computer 010 is configured to store, in the auxiliary storage device 013, the target recognition program 111, the recognition time band determination program 112, reference dictionary data 211, and threshold data 212. The target recognition program 111 and the recognition time band determination program 112 are read into a memory 012, and executed by a processor (CPU) 011. The reference dictionary data 211 and the threshold data 212 may be stored in the external storage apparatus 050.

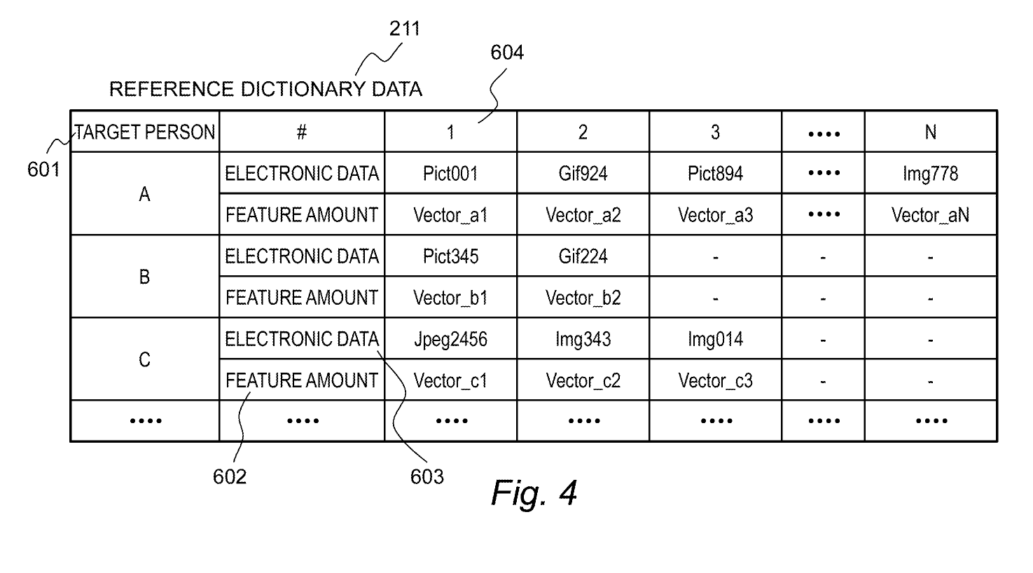

A data structure of the reference dictionary data 211 is now described with reference to FIG. 4. The reference dictionary data 211 is constructed from one or more pieces of electronic data (images) 603 registered in advance for each target person or target object 601. The registered images are usually converted into vector data, for example, by calculating in advance a feature amount 602 in order to perform a rapid similarity degree calculation. The target recognition program 111 only handles the feature amount 602, and hence the images may be deleted after the feature calculation. For a target person having two or more feature amounts, the target person is registered by adding a registration number 604 thereto. A feature amount may also be registered by merging a plurality of registrations into a single piece of data.

The threshold data 212 is configured to store a threshold to be used by the target recognition program 111.

The computer 020, which includes the video editing program 121, is configured to function as a video editing module by the processor executing the video editing program 121. The computer 030, which includes the video search/playback program 131, is configured to function as a video search/playback module by the processor executing the video search/playback program 131.

Next, one example of video information indexing processing is described for a case in which only one person is detected from video. The target recognition program 111 is configured to sequentially read into the memory 012 a plurality of video files included in the video data 251.

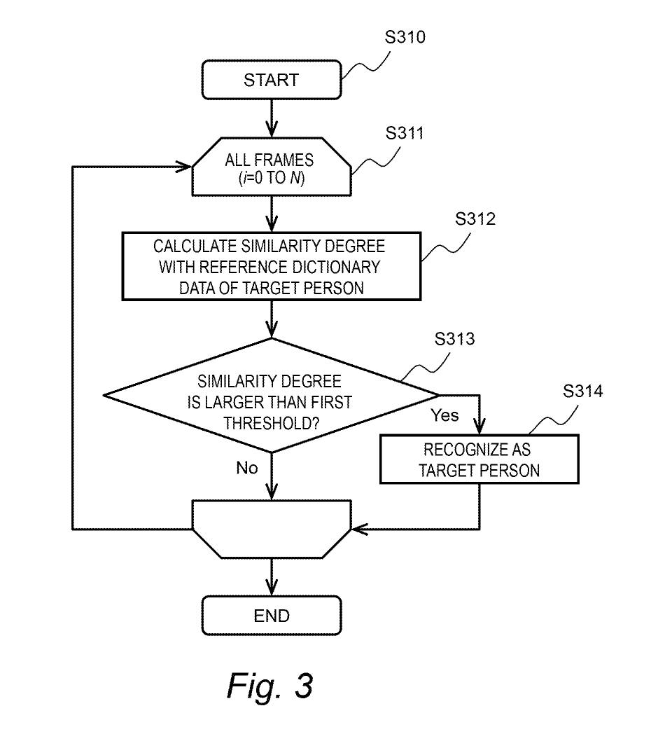

In FIG. 3, a sequence (S310) for generating the recognition frame data 252 from a read video file is illustrated.

First, for all the frames in the video file (or, frames extracted at uniform intervals) (S311), a similarity degree is calculated by performing pattern matching with the reference dictionary data 211 (or, feature amount comparison) (S312). In this step, similarity degree=100 means a perfect match with a specific person (or object), and similarity degree=0 means that there is no similarity at all, namely, a different person or object. Next, a first threshold is read from the threshold data 212, and compared with the calculated similarity degree (S313). The first threshold, which is set in advance, is a quantitative reference value for determining whether or not a specific person is present based on the similarity degree.

In a case where the calculated similarity degree is equal to or more than the first threshold, the specific person is determined to be present in the relevant frame (S314). In this case, because a single person is the target, it is sufficient to compare with the feature amount of the relevant single target person (e.g., target person A) by using a reference dictionary data structure 600. The similarity degree is stored in the external storage apparatus 050 as recognition frame data. The steps from Steps S311 to S313 and from Steps S311 to S314 are performed on all the frames.

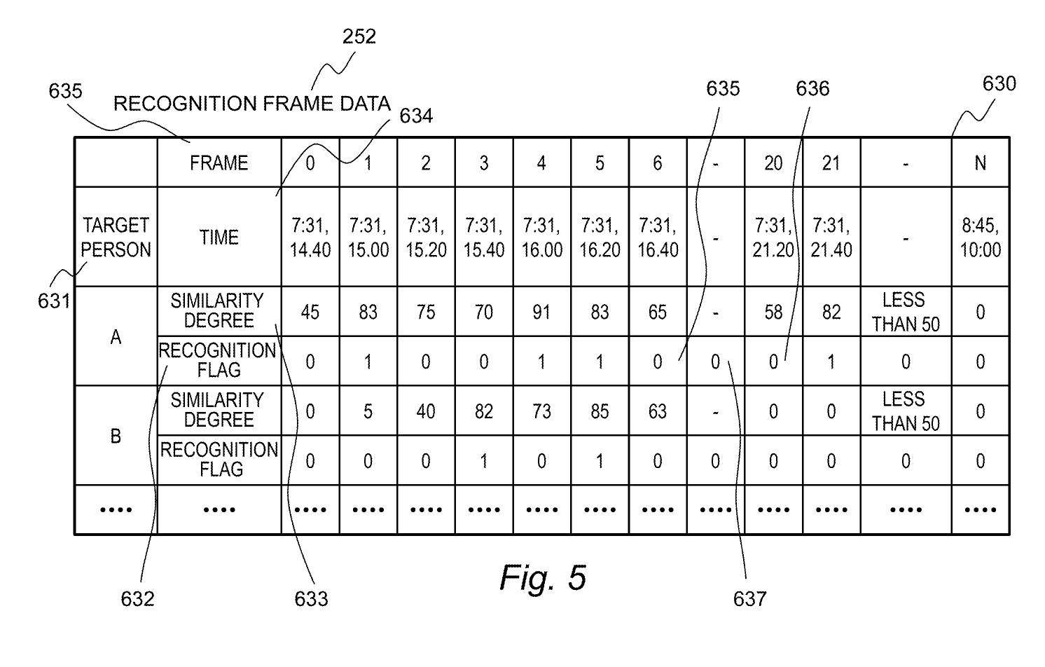

In FIG. 5, one example of a data structure of the recognition frame data 252 is illustrated.

Each frame is managed as time elapses together with time (634). For example, the time of a frame 1 is 7:31:14.40. A similarity degree 633 with the registration data of the person being searched for (or object being searched for) 631, which is the search target, is stored for each frame 635. Further, a determination result is written in a recognition flag 632 based on whether or not the similarity degree is equal to or more than the first threshold. In a case where the recognition flag 632 is a value of 1, this means that it has been determined that the registration data is present in the frame. The sequence described above is performed on all the target frames, and the frame data is recorded (S311).

Next, the recognition time band determination program 112 corrects the generated recognition frame data 252 in consideration of changes to the similarity degree in times series, and generates the recognition time band data 253 (S330).

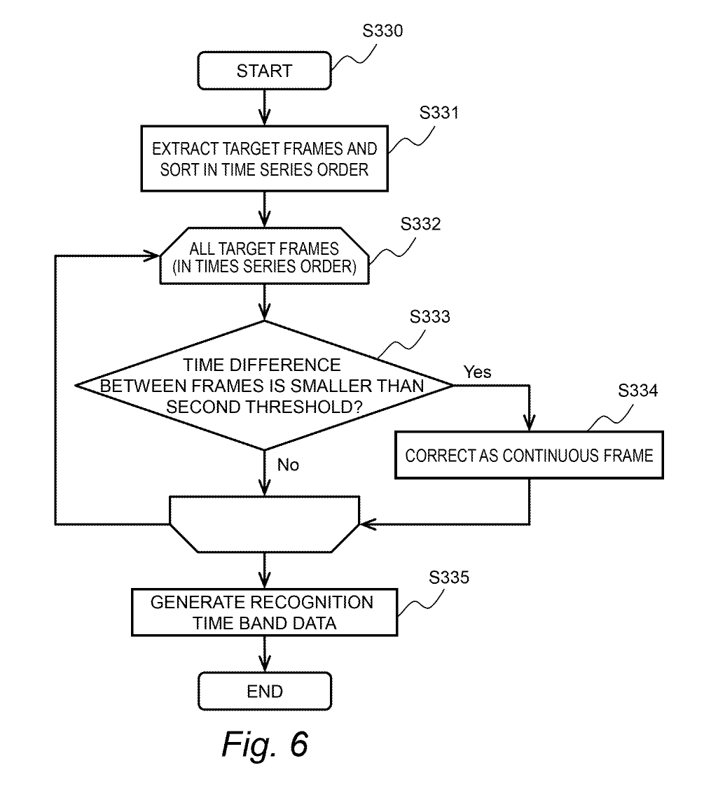

Recognition time band data generation processing is now described in detail with reference to FIG. 6. First, the frames having a value of 1 for the recognition flag 632 in a recognition frame data structure 630 are extracted and sorted in time series (S331). Next, the following sequence is executed in time series order on all the extracted target frames as targets for determination processing (S332).

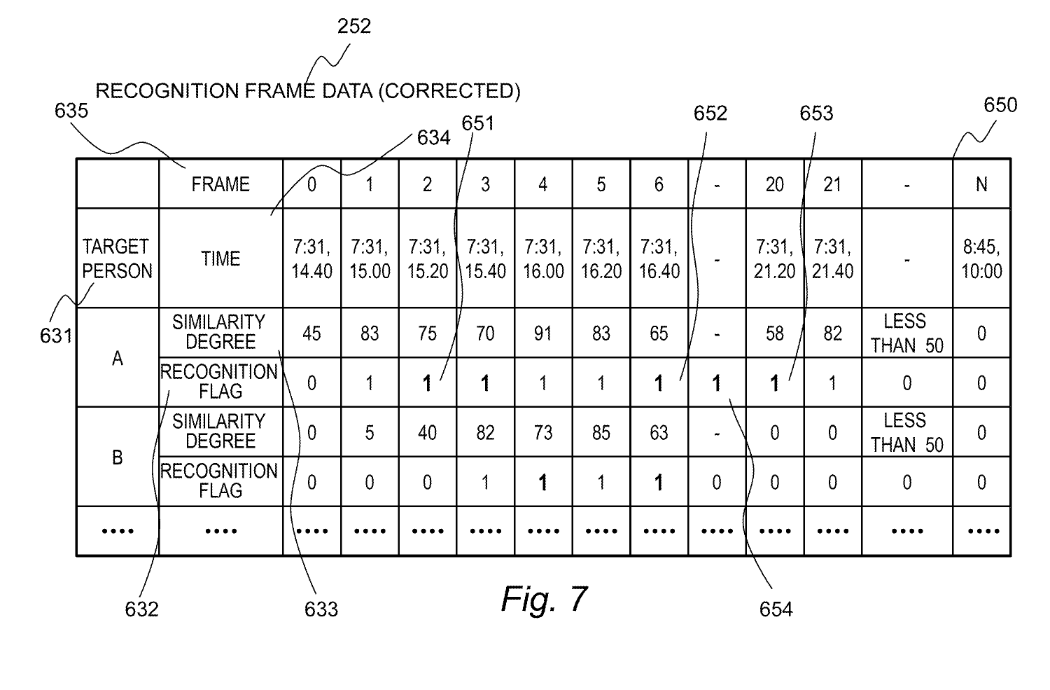

First, a difference in times 634 between a relevant frame and the next frame for which a determination is made in Step S331 is calculated. This time difference and a second threshold read from the threshold data 212 are then compared (S333). In a case where the time difference is smaller than the second threshold, the frame data is corrected as being a continuous frame (S334). The second threshold, which is set in advance, represents the maximum time difference for which a frame can be determined as being a continuous frame in which the target person is shown. In other words, the second threshold represents the maximum time difference for which, even when there is a frame in which the target person is not shown, those frames can be permitted to be defined as being a single connected video clip. For example, in FIG. 5, for the target person A, the time difference between the first frame and the fourth frame is 1 second. In a case where the second threshold is 5 seconds, the frames between the first frame and the fourth frame are determined as being continuous frames in which the target person A is continuously shown. As a result, the recognition flag is set, and the recognition frame data is corrected (illustrated by 651 in FIG. 7). The above-mentioned sequence is performed on all the extracted frames (S332). For example, in a moving image in which a given person is giving a speech on a stage, scenes are occasionally inserted in which the camera faces the audience. With the processing described above, the moving image can be recognized as being a single scene even when a scene in which the target person is not shown is inserted.

Lastly, the recognition time band data 253 is generated by using the corrected recognition frame data 252 (S335). In this case, the recognition time band is the time between a start time and an end time in which the target person is shown in the video.

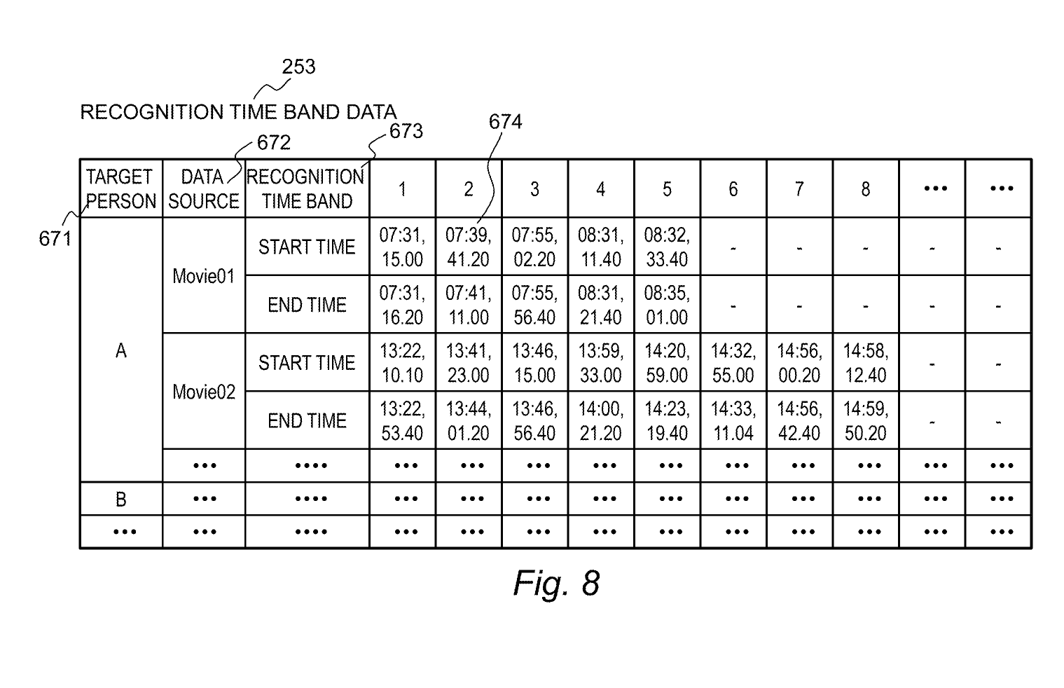

In FIG. 8, one example of a data structure of the recognition time band data 253 is illustrated. For each target person 671, a time band 673 of the data source 672 in which the relevant target person is shown is recorded. This is performed by referring to the recognition flag 632 of recognition frame data (corrected) 650, and writing in the recognition time band the start time and end time 674 of continuous frames having a flag value of 1 (S334). At this stage, in a case where there are few frames that are continuous (e.g., within 3 seconds in terms of time), the utility value of those frames as video footage is determined to be low. In such a case, processing for not writing in the recognition time band may be executed.

The recognition time band data 253 at this point starts and ends at frames in which the target person (e.g., A) is clearly shown facing the front. An actual video includes frames in which the target person is facing to the side or downward, or frames in which the target person has been cut out of, and hence the similarity degree is continuously increasing and decreasing. To appropriately capture the scenes before and after such a situation, the recognition time band data 253 is corrected (S350). Specifically, a third threshold is read from the threshold data 212. The third threshold is a lower value than the first threshold. As a result, in a case where there is a frame having a similarity degree that, although lower than the first threshold before and after the recognition time band, is a certain level or more, the target person is determined as being shown in that frame. The recognition time band determination program 112 that is used to perform this determination again refers to the recognition flag 632 of the recognition frame data (corrected) 650 and the recognition time band data 253, and corrects the recognition time band data 253.

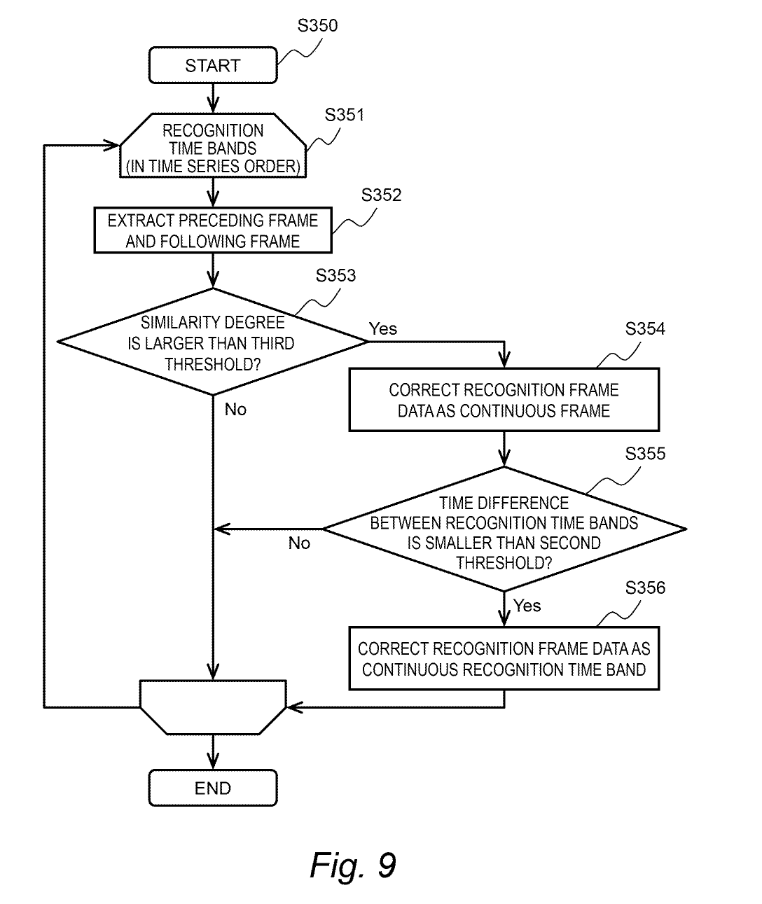

The processing for correcting the recognition time band data is now described in detail with reference to FIG. 9.

First, for the target person, the recognition time band 673 is referred to in time series from the recognition time band data 253 (S351). For example, in the case of the start time 674 of the second recognition time band, several seconds or several frames (the extraction range is defined in advance) immediately before 07:39:41.20 are extracted from the recognition frame data 252 (S352), and the similarity degree with the target person is compared with the third threshold (S353). In a case where the similarity degree is larger than the third threshold, the recognition frame data is corrected as being a continuous frame (S354). For example, the sixth frame 635 illustrated in FIG. 5 is close to the end frame (07:31:16.20) of the recognition time band, but the sixth frame 635 is not included in the recognition time band. In contrast, in a case where the third threshold is set lower than the first threshold (e.g., 50), the sixth frame can be included in the recognition time band (illustrated by 652 in FIG. 7).

As a result, because a case occurs in which the gap between recognition time bands shortens, a determination is again made using the second threshold whether or not the frame is continuous (S355), and the recognition frame data is corrected (S356). For example, in FIG. 5, as a result of the determination of the preceding frame and the following frame, the recognition flags (635 and 636) of the sixth frame and the twentieth frame are corrected to 1 (illustrated by 652 and 653 in FIG. 7). Further, in a case where the second threshold is set to 5 seconds, because the seventh frame and the nineteenth frame can be determined as being continuous recognition time band data, the recognition flag 637 illustrated in FIG. 5 is changed as illustrated by recognition flag 654 in FIG. 7. As a result, the recognition time bands in FIG. 8 that are close to each other are merged into a single recognition time band. The sequence described above is performed on all the recognition time bands.

Thus, according to this embodiment, a frame in which a specific target person or target object has been recognized can be cut out together with the surrounding frames as a single scene, and attribute information can be added thereto.

### Second Embodiment

Next, one example of video information indexing processing is described for a case in which a plurality of people are detected from the video. In this embodiment, because the processing is basically the same as the processing performed in the case of detecting a single person, parts that are not particularly described in this embodiment are the same as the processing described in the first embodiment.

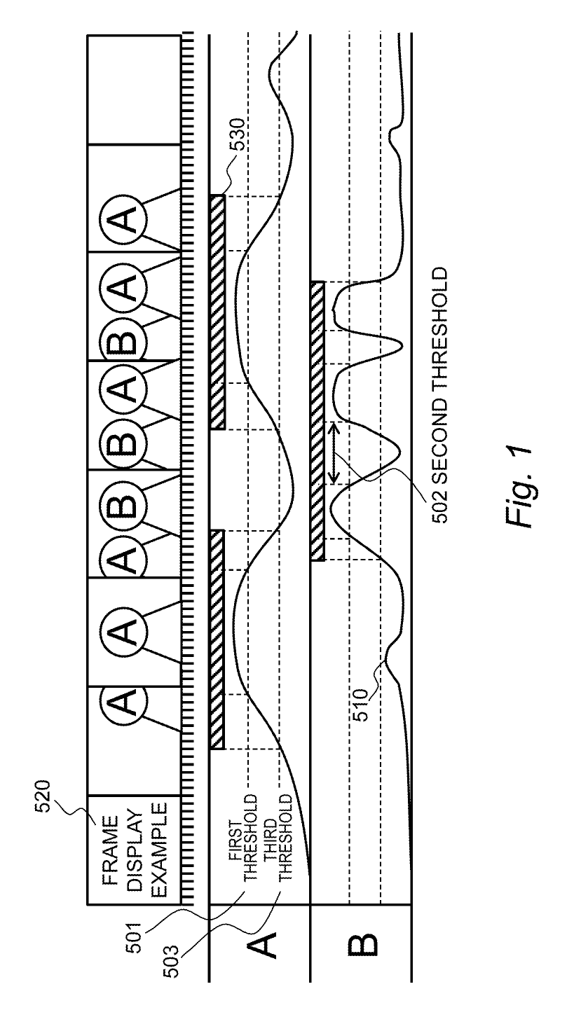

FIG. 1 is an example for conceptually illustrating this invention. As described in the first embodiment, a primary detection of a recognition frame is performed by using the first threshold (501), a continuous frame is determined by using the second threshold (502), and a determination is made regarding whether or not to include frames that are close before and after the recognition time band by using the third threshold (503). In a case where there are a plurality of target people, those processing steps are performed on each target person.

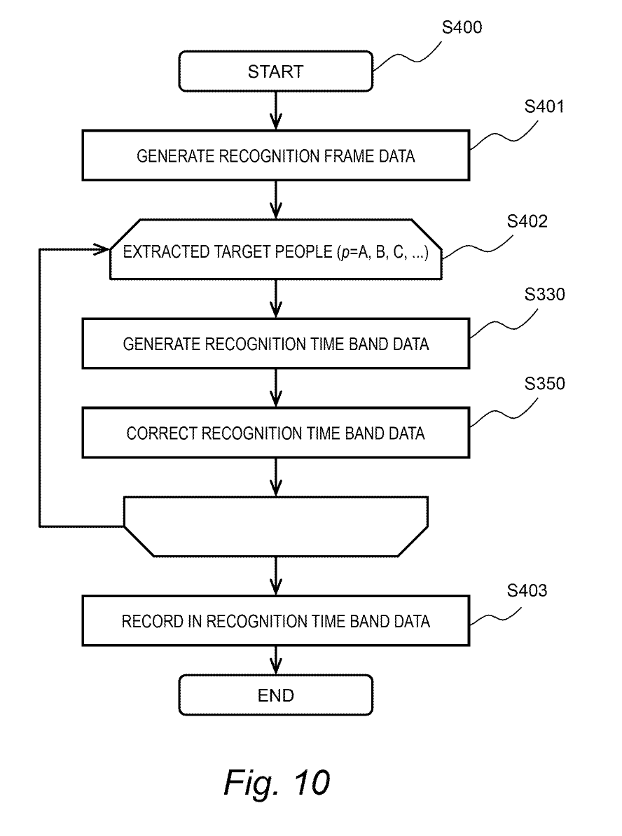

In FIG. 10, a flow S400 of the overall processing is illustrated. First, the recognition frame data is generated, and the plurality of target people shown in the video are specified by using the reference dictionary data 211 (S401). For each of the target people (S402) specified based on this processing, recognition time band data generation (S330) and recognition time band data correction (S350) are performed in the same manner as in the first embodiment. In the recognition time band data 253 that is generated as a result, as illustrated in FIG. 8, results are registered for a plurality of target people A and B. In other words, which data source 672 and which time band 673 each specified target person 671 is shown in are recorded in the recognition time band data 253 (S403).

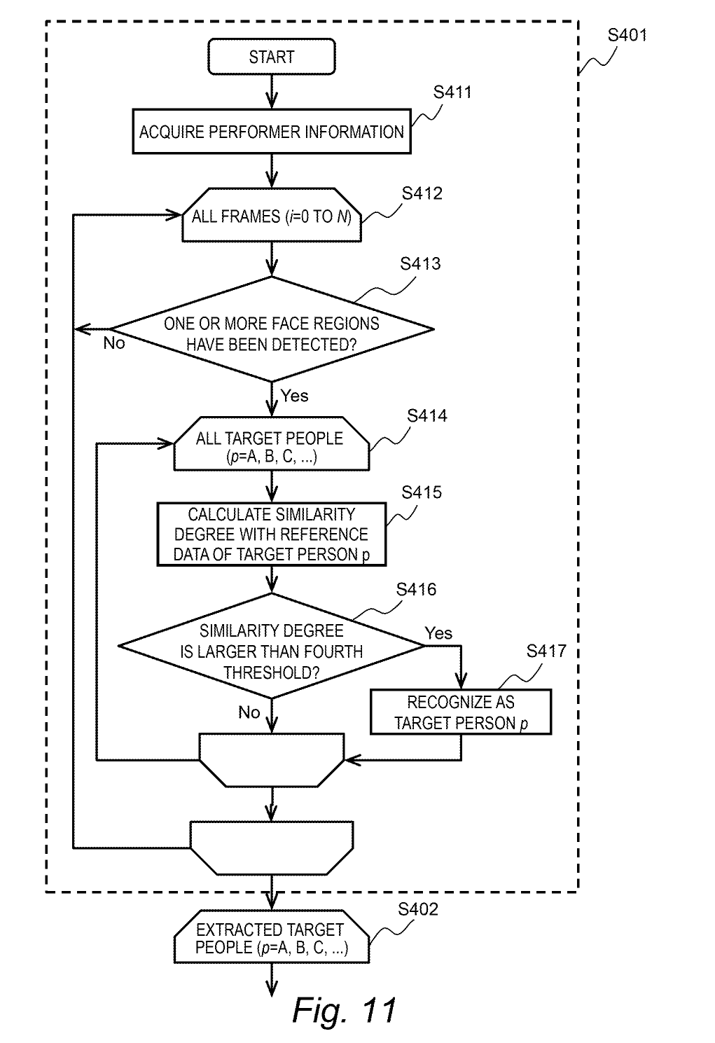

In FIG. 11, the recognition frame data generation processing (S401) performed to detect a plurality of people is illustrated in detail.

In this processing, for example, because all the target people present in the reference dictionary data are basically compared with a plurality of face regions detected in each frame, the processing amount becomes very large. In order to avoid this, a processing step may be added for narrowing down the number of target people based on the number of face regions and the number of target people (illustrated by 601 in FIG. 4) to be used as search targets. For example, the processing amount may be substantially reduced by linking to a database, such as electric television program data (electric program guide (EPG)), which is associated with the data source 672, acquiring in advance the names of the performers having a target number (S411), and using the dictionary data of the target people associated with the acquired names as search targets.

Next, the following processing is performed on all the frames in the target data source (S412). First, face regions are detected. In a case where one or more face regions are not present in the frame (No in S413), the processing described below is skipped, and the processing proceeds to the next step.

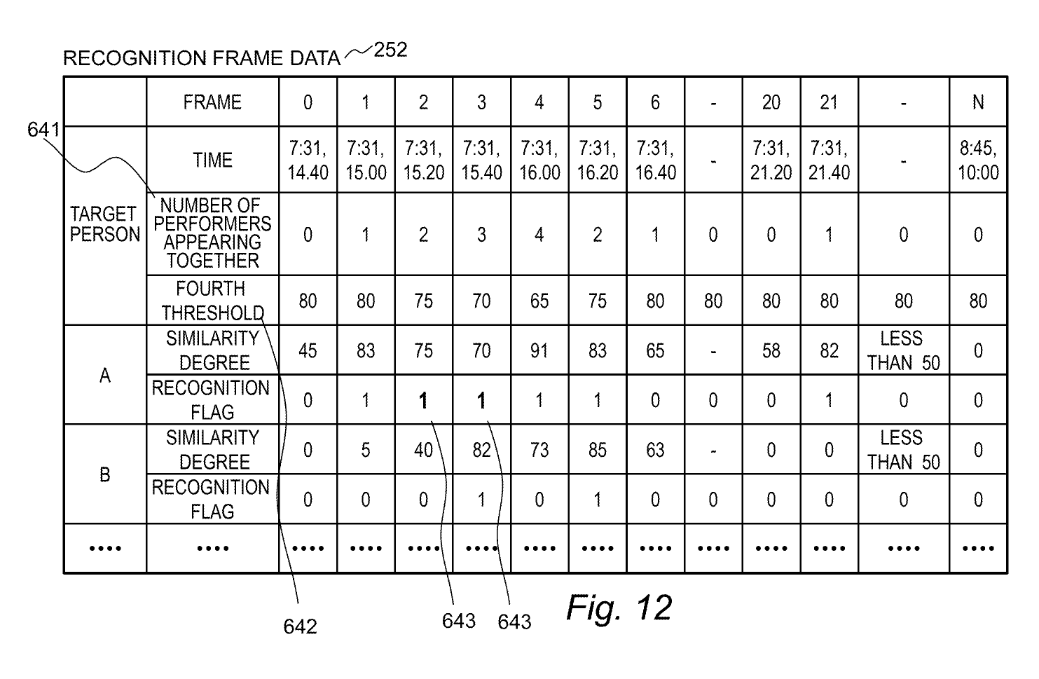

An example of a recognition frame data structure is illustrated in FIG. 12. In this case, the number of detected face regions is written in a number of performers appearing together 641 for each still image. For each target person narrowed down based on performer information (S414), a similarity degree is calculated (S415). Then, in a case where the similarity degree is larger than a fourth threshold (Yes in S416), each person for which a face region has been detected is recognized as being a target person p (S417). In a case where a plurality of people are shown in one frame, there is a high likelihood of people overlapping as time progresses, which can lead to problems with face detection at an ordinary accuracy level. In order to avoid this, the risk of unstable face detection can be reduced by decreasing the threshold for detection (S416) based on the number of performers appearing together 641. For example, the threshold may be set to a value lower by a predetermined ratio when the number of performers appearing together is a predetermined value or more.

In FIG. 12, an example is illustrated in which the recognition flag is set by using the fourth threshold (642) to 80 (default value of the first threshold) in a case where the number of performers appearing together is 1 or less, 75 in a case where the number of performers appearing together is 2, 70 in a case where the number of performers appearing together is 3, . . . . With this configuration, the start time and the end time of the scenes in which each of a plurality of search targets appear can be managed. A recognition flag 643 of the target person A for the second and third frames, for example, can be changed by using a threshold lower than the ordinary first threshold.

One characteristic of detecting a plurality of people is that it enables a video clip to be extracted in a case where co-performers appear together in a television program as a set. For example, in a case where the combination of the target person A and the target person B is the target, it suffices that frames in which the recognition flag of the target person A and the recognition flag of the target person B are both set to 1 are extracted based on the recognition frame data 252 illustrated in FIG. 12, the processing of recognition time band data generation 330 and recognition time band data correction 350 is performed on the extracted frames, and the number of frames in which the target person A and the target person B are both shown is registered.

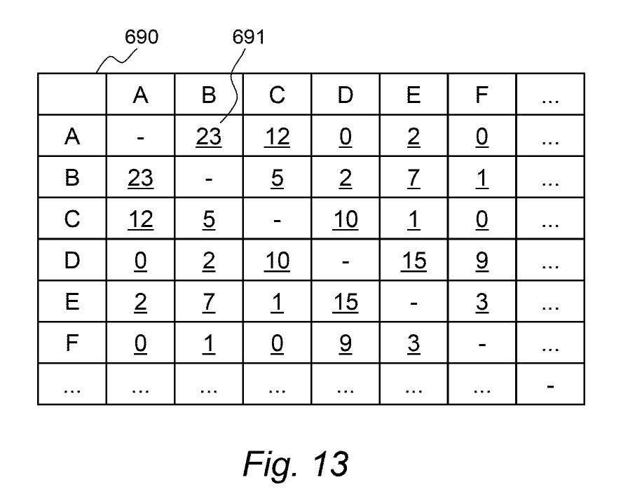

In FIG. 13, for example, for a combination of two search targets, a screen output example of the number of recognition time bands in which the relevant search targets have been determined as being present is illustrated. It can be seen that when a number 691 indicating the number of still images is larger, the number of co-appearances is greater. Those numbers may themselves be linked to a page for playing back the relevant video clips.

Lastly, an example in which the video search/playback program 131 searches the video by referring to generated recognition time band data 253 is described as a configuration common to the first and second embodiments.

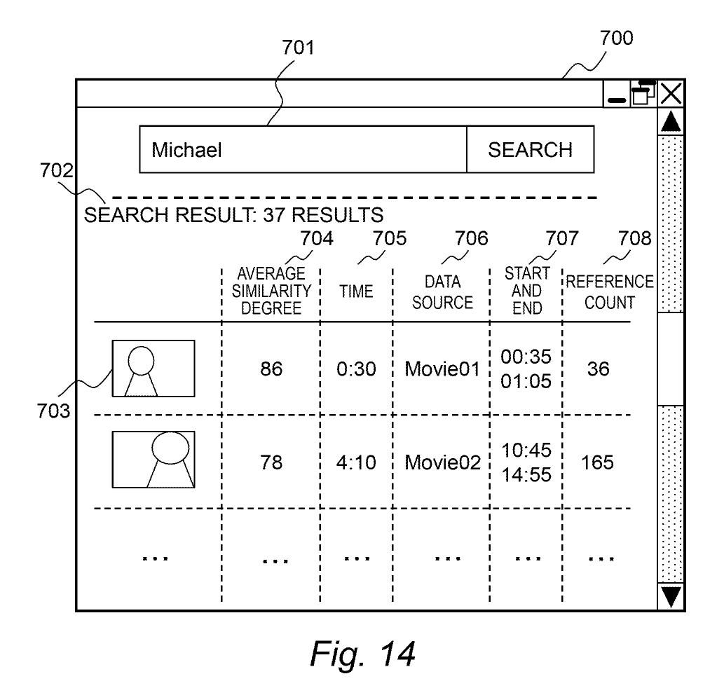

FIG. 14 is a diagram for illustrating an example of a search screen. The example of the search screen illustrated in FIG. 14 is realized via an input and output apparatus coupled to the computers 020 and 030. When the name of the target person to be searched for is input to a keyword input field 701, a list 702 is displayed of the recognition time bands registered in relation to the relevant target person 671 of the recognition time band data 253 illustrated in FIG. 8.

As illustrated in FIG. 8, a video display region 703 may be arranged for displaying, in relation to the list, one frame (e.g., the first frame) included in the recognition time band. As reference information, an average value 704 of the similarity degree of the target person for all the frames in the recognition time band may be calculated based on the recognition frame data 252 and displayed. In this case, the list may also be rearranged in decreasing order of average similarity degree and displayed.

A reference count 708 indicates the number of times the user of the system has played back the video of the relevant recognition time band. Video with a high playback count may be determined as being a popular playback clip, and hence the list may be rearranged in decreasing order of playback count and displayed.

Further, the list 702 may also include a video playback time 705, a data source 706 indicating the original file name, and a start and end time 707 of the recognition time band (video clip).

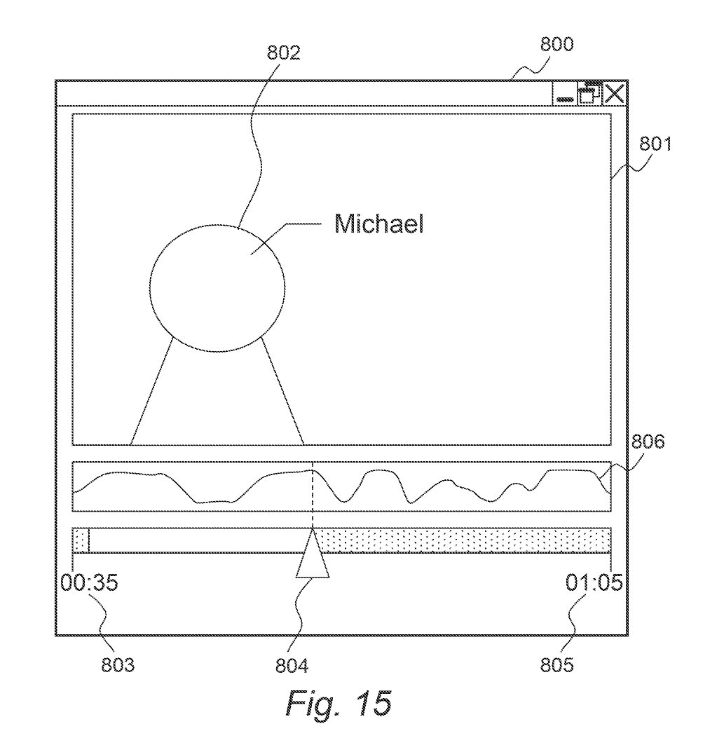

An example of a screen 800 for playing back a recognition time band video by using the video search/playback program 131 is illustrated in FIG. 15. In a video display region 801, a person 802 input basically by a search keyword is continuously shown. A start time 803 and an end time 805 indicate a start time and an end time, respectively, of the relevant recognition time band. Further, a times series variation 806 of the similarity degree of each frame may be displayed by using the recognition frame data 252. The video search/playback program 131 may have a function of changing the playback speed and/or a playback necessity based on the similarity degree. Use of this function to skip or fast forward through the display of the video for frames having a low similarity degree allows more effective viewing in consideration of the similarity degree. Further, the name of the relevant person may be displayed near the face of that person 802 by using information on face region detection of each frame to specify the coordinates in which the relevant person is shown. This is effective for people recognition and viewing when a plurality of people are shown simultaneously.

This invention is not limited to the above-described embodiments but includes various modifications and equality configurations within the scope of the claimed invention. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (Solid State Drive), or a storage medium such as an IC card, an SD card, or a DVD.

The drawings illustrate control lines and information lines as considered necessary for explanation but do not illustrate all control lines or information lines in the products. It can be considered that almost of all components are actually interconnected.

What is claimed is:

1. A video information processing system for processing a moving image formed of a plurality of still images in times series, comprising:
a target recognition module configured to detect, from among the plurality of still images, still images in which a search target is present based on a determination of a similarity degree with registration data of the search target using a first threshold; and
a time band determination module configured to determine, in a case where an interval between the still images in which the search target is determined as being present is a second threshold or less, that the search target is also present in a still image between the still images in which the search target is determined as being present,
wherein the video information processing system is configured to register a start time and an end time of the continuous still images in which the search target is determined as being present in association with the registration data of the search target.

2. The video information processing system according to claim 1, wherein the video information processing system is configured to determine similarity degrees for still images included within a predetermined range in time series from the still images in which the search target is determined as being present by using a third threshold lower than the first threshold.

3. The video information processing system according to claim 1, wherein the video information processing system is configured to determine, in a case where there are a plurality of the search targets, similarity degrees for still images in which the plurality of the search targets are simultaneously included by using a fourth threshold lower than the first threshold.

4. The video information processing system according to claim 1, further comprising a playback module configured to output the continuous still images registered in association with an input search target,
wherein the playback module is configured to change at least one of a playback speed or a playback necessity of a relevant still image based on a similarity degree of the relevant still image with each piece of the registration data of the plurality of still images.

5. The video information processing system according to claim 1, wherein the video information processing system is configured to:
acquire data of a target appearing in the moving image; and
use, from among a plurality of pieces of the registration data that has been recorded, a piece of the registration data of a target appearing in a moving image to be processed as the registration data of the search target.
